(19) United States
(12) Patent Application Publication
(10) Pub. No.: US 2005/0280189 A1
(43) Pub. Date: Dec. 22, 2005

(54) Undercut For Bushing Retention For SLS Details

(75) Inventors: John G. Macke Jr., St. Louis, MO (US); Jack G. Buchheit, St. Charles, MO (US); Nancy Samson, St. Charles, MO (US)

Correspondence Address: ARTZ & ARTZ, P.C., 28333 TELEGRAPH RD., SUITE 250, SOUTHFIELD, MI, 48034, US

(73) Assignee: THE BOEING COMPANY, Chicago, IL (US)

(21) Appl. No.: 10/710,144

(22) Filed: Jun. 22, 2004

(51) Int. Cl. B29C 35/08; B29C 41/02

(52) U.S. Cl. 264/497; 29/458

(57) ABSTRACT

In accordance with one aspect of the present invention, a system for manufacturing a tool within a laser sintering system includes a chamber enclosing a sinter material. The laser sintering system grows or sinters sections of the tool and tool contoured details from the sinter material in response to signals from a controller, wherein controller generates the signals as a function of a predetermined tool design. The contoured details include attachment holes, which are strengthened by bushings.

### BACKGROUND OF INVENTION

The present invention relates generally to tooling systems and processes and is more specifically related to the fabrication of tools through selective laser sintering.

Traditional fabrication methods for tools having areas of contour have included fiberglass lay-ups on numerically controlled machined master models or facility details.

A manufacturing master model tool, or “master model”, is a three-dimensional representation of a part or assembly. The master model controls physical features and shapes during the manufacture or “build” of assembly tools, thereby ensuring that parts and assemblies created using the master model fit together.

Traditional tool fabrication methods rely on a physical master model. These master models may be made from many different materials including: steel, aluminum, plaster, clay, and composites; and the selection of a specific material has been application dependent. Master models are usually hand-made and require skilled craftsmen to accurately capture the design intent. Once the master model exists, it may be used to duplicate tools.

The master model becomes the master definition for the contours and edges of a part pattern that the master model represents. The engineering and tool model definitions of those features become reference only.

Root cause analysis of issues within tool families associated with the master has required tool removal from production for tool fabrication coordination with the master. Tools must also be removed from production for master model coordination when repairing or replacing tool details. Further, the master must be stored and maintained for the life of the tool.

Master models are costly in that they require design, modeling and surfacing, programming, machine time, hand work, secondary fabrication operations, and inspection prior to use in tool fabrication.

In summary, although used for years, physical master models have inherent inefficiencies, including: they are costly and difficult to create, use, and maintain; there is a constant risk of damage or loss of the master model; and large master models are difficult and costly to store.

By way of further background, the field of rapid prototyping of parts has, in recent years, made significant improvements in providing high strength, high density parts for use in the design and pilot production of many useful objects. “Rapid prototyping” generally refers to the manufacture of objects directly from computer-aided-design (CAD) databases in an automated fashion, rather than from conventional machining of prototype objects following engineering drawings. As a result, time required to produce prototype parts from engineering designs has been reduced from several weeks to a matter of a few hours.

An example of a rapid prototyping technology is the selective laser sintering process (SLS) in which objects are fabricated from a laser-fusible powder. According to this process, a thin layer of powder is dispensed and then fused, melted, or sintered, by a laser beam directed to those portions of the powder corresponding to a cross-section of the object.

Conventional selective laser sintering systems position the laser beam by way of galvanometer-driven mirrors that deflect the laser beam. The deflection of the laser beam is controlled, in combination with modulation of the laser itself, for directing laser energy to those locations of the fusible powder layer corresponding to the cross-section of the object to be formed in that layer. The laser may be scanned across the powder in a raster fashion or a vector fashion.

In a number of applications, cross-sections of objects are formed in a powder layer by fusing powder along the outline of the cross-section in vector fashion either before or after a raster scan that fills the area within the vector-drawn outline. After the selective fusing of powder in a given layer, an additional layer of powder is then dispensed and the process repeated, with fused portions of later layers fusing to fused portions of previous layers (as appropriate for the object), until the object is completed.

Selective laser sintering has enabled the direct manufacture of three-dimensional objects of high resolution and dimensional accuracy from a variety of materials including polystyrene, NYLON, other plastics, and composite materials, such as polymer coated metals and ceramics. In addition, selective laser sintering may be used for the direct fabrication of molds from a CAD database representation of the object in the fabricated molds. Selective Laser Sintering has, however, not been generally applicable for tool manufacture because of SLS part size limitations, lack if robustness of SLS objects, and inherent limitations in the SLS process.

The disadvantages associated with current tool manufacturing systems have made it apparent that a new and improved tooling system is needed. The new tooling system should reduce need for master models and should reduce time requirements and costs associated with tool manufacture. The new system should also apply SLS technology to tooling applications. The present invention is directed to these ends.

### SUMMARY OF INVENTION

In accordance with one aspect of the present invention, a system for manufacturing a tool within a laser sintering system includes a chamber enclosing a sinter material. The laser sintering system grows or sinters sections of the tool and tool contoured details from the sinter material in response to signals from a controller. The controller generates the signals as a function of a predetermined tool design. The contoured details include attachment holes, which are strengthened by bushings.

In accordance with another aspect of the present invention, a method for laser sintering a tool includes predetermining a position of a contoured detail feature. The method further includes predetermining a configuration for the contoured detail feature such that the contoured detail feature includes securing features for coupling strengthening components thereto. The contoured detail is sintered, and a strengthening component is coupled thereto, thereby reducing stress on the contoured detail feature.

One advantage of the present invention is that use of Selective Laser Sintering can significantly reduce costs and cycle time associated with the tool fabrication process. An additional advantage is that tool features can be “grown” as represented by the three-dimensional computer model, thus eliminating the requirement for a master model or facility detail. The subsequent maintenance or storage of the master/facility is thereby also eliminated.

Still another advantage of the present invention is that the model remains the master definition of the tool, therefore root cause analysis or detail replacement may be done directly from the model definition. Secondary fabrication operations are further eliminated where features are “grown” per the three-dimensional solid model definition.

Additional advantages and features of the present invention will become apparent from the description that follows, and may be realized by means of the instrumentalities and combinations particularly pointed out in the appended claims, taken in conjunction with the accompanying drawings.

### BRIEF DESCRIPTION OF DRAWINGS

In order that the invention may be well understood, there will now be described some embodiments thereof, given by way of example, reference being made to the accompanying drawings, in which:

FIG. 1 illustrates a sintering system in accordance with one embodiment of the present invention;

FIG. 2 illustrates a perspective view of a tool, fabricated in the system of FIG. 1, in accordance with another embodiment of the present invention;

FIG. 3 illustrates an enlarged partial view of FIG. 2;

FIG. 4 illustrates a cutaway view of a contoured detail of the tool of FIG. 2 in accordance with another embodiment of the present invention; and

FIG. 5 illustrates a logic flow diagram of a method for operating a sintering system in accordance with another embodiment of the present invention.

### DETAILED DESCRIPTION

The present invention is illustrated with respect to a sintering system particularly suited to the aerospace field. The present invention is, however, applicable to various other uses that may require tooling or parts manufacture, as will be understood by one skilled in the art.

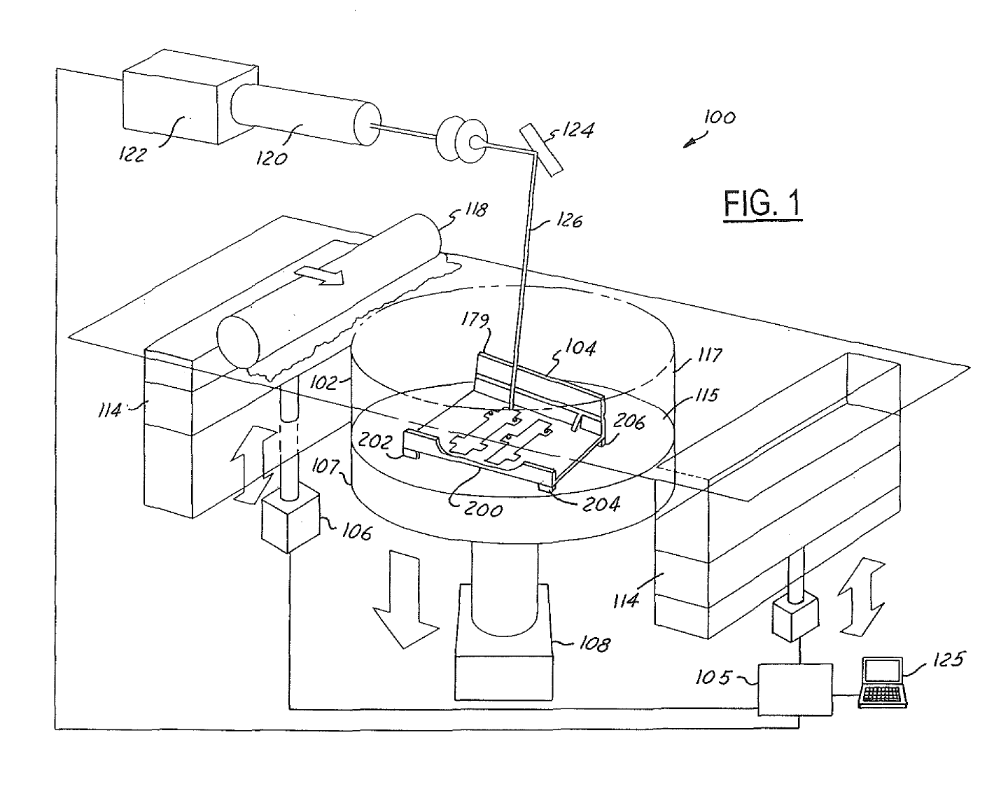

FIG. 1 illustrates a selective laser sintering system 100 having a chamber 102 (the front doors and top of chamber 102 not shown in FIG. 1, for purposes of clarity). The chamber 102 maintains the appropriate temperature and atmospheric composition (typically an inert atmosphere such as nitrogen) for the fabrication of a tool section 104. The system 100 typically operates in response to signals from a controller 105 controlling, for example, motors 106 and 108, pistons 114 and 107, roller 118, laser 120, and mirrors 124, all of which are discussed below. The controller 105 is typically controlled by a computer 125 or processor running, for example, a computer-aided design program (CAD) defining a cross-section of the tool section 102.

The system 100 is further adjusted and controlled through various control features, such as the addition of heat sinks 126, optimal objection orientations, and feature placements, which are detailed herein.

The chamber 102 encloses a powder sinter material that is delivered therein through a powder delivery system. The powder delivery system in system 100 includes feed piston 114, controlled by motor 106, moving upwardly and lifting a volume of powder into the chamber 102. Two powder feed and collection pistons 114 may be provided on either side of part piston 107, for purposes of efficient and flexible powder delivery. Part piston 107 is controlled by motor 108 for moving downwardly below the floor of chamber 102 (part cylinder or part chamber) by small amounts, for example 0.125 mm, thereby defining the thickness of each layer of powder undergoing processing.

The roller 118 is a counter-rotating roller that translates powder from feed piston 114 to target surface 115. Target surface 115, for purposes of the description herein, refers to the top surface of heat-fusible powder (including portions previously sintered, if present) disposed above part piston 107; the sintered and unsintered powder disposed on part piston 107 and enclosed by the chamber will be referred to herein as the part bed 117. Another known powder delivery system feeds powder from above part piston 107, in front of a delivery apparatus such as a roller or scraper.

In the selective laser sintering system 100 of FIG. 1, a laser beam is generated by the laser 120, and aimed at target surface 115 by way of a scanning system 122, generally including galvanometer-driven mirrors 124 deflecting the laser beam 126. The deflection of the laser beam 126 is controlled, in combination with modulation of laser 120, for directing laser energy to those locations of the fusible powder layer corresponding to the cross-section of the tool section 104 formed in that layer. The scanning system 122 may scan the laser beam across the powder in a raster-scan or vector-scan fashion. Alternately, cross-sections of tool sections 104 are also formed in a powder layer by scanning the laser beam 126 in a vector fashion along the outline of the cross-section in combination with a raster scan that “fills” the area within the vector-drawn outline.

Referring to FIGS. 1, 2, and 3, a sample tool 150 formed through the SLS system 100 is illustrated. The tool 150 includes a plurality of large sections (first 152, second 154, and third 156) or alternately one large section. The sections 152 (alternate embodiment of 104 in FIG. 1), 154, 156 may be sintered simultaneously or consecutively.

During the sintering process, various features are molded into the large tool section or sections. Such features include steps and thickness variations 158, gussets 160, stiffeners 162, interfaces and coordination features for making interfaces 164, construction ball interfaces and coordination holes 170, trim of pocket and drill inserts 166, hole patterns 172, and holes 168 included in multiple details for interfacing hardware, such as detail 180. Important to note is that a first plurality of features, including a combination of the aforementioned features, may be sintered into the first section 152 and a second plurality of features, including a combination of the aforementioned features, may be sintered into the second section 154.

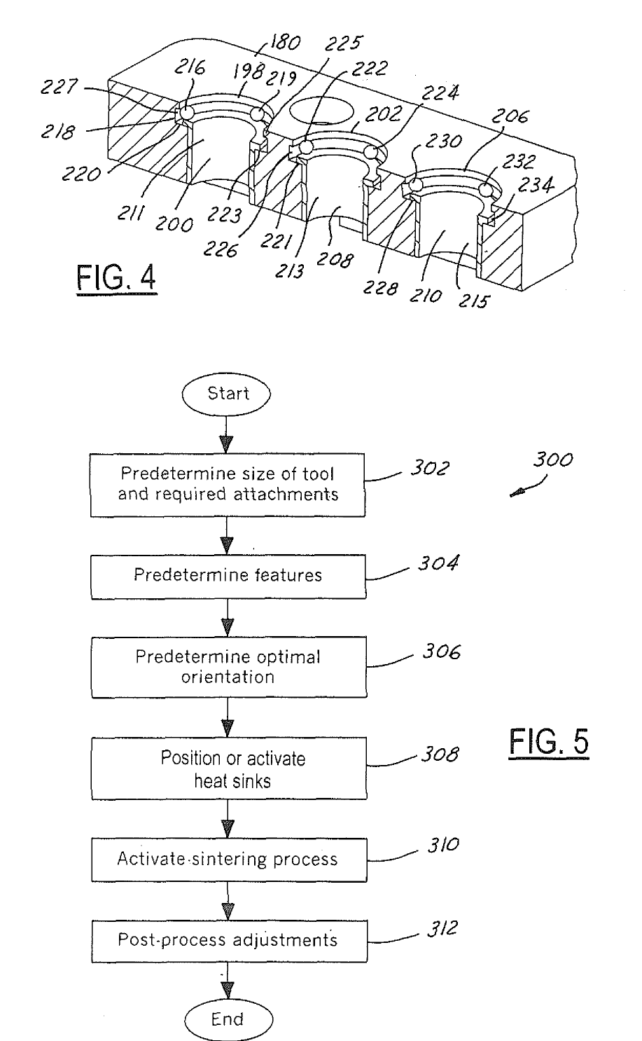

Individually contoured details, such as detail 180, which may also be considered sections of the tool for the purposes of the present invention, may be sintered separately from the main body of the tool 150, such that they may be easily replaced or replaceable or easily redesigned and incorporated in the tool 150. Alternate embodiments include a plurality of individual contoured details, such as 180, 182, 184, and 186. Each of the contoured details includes holes, e.g. 168, such that a bolt 190 may bolt the detail 180 to a section 152, 154, or 156 of the tool 150. The contoured details 180 further define holes or openings 198 strengthened by bushings 200. The openings 198 reduce friction acting on and strengthen the contoured detail 180 such that other tools, tool components, or devices may be coupled thereto. The contoured detail 180 and the bushings 200 will be discussed further regarding FIG. 4.

The features, such as the gusset 160 and the stiffener 162 are, in one embodiment of the present invention, grown on the same side of the SLS tool 150. Growing (i.e. sintering) these features on the same side of the tool takes advantage of the sintering process because a feature grown at the beginning of a sintering operation has different properties than the same feature would when grown at the end of a sintering operation. Therefore, the first side 200 undergoing sintering includes all the tool features.

Alternate embodiments of the present invention include various tool features grown on either side of the tool 150 through various other methods developed in accordance with the present invention. One such method includes adding a heat sink 202, or a plurality of heat sinks 202, 204, 206 to various portions of the bed 117 such that different tool features may be cooled subsequent to sintering on the first section 152 or second section 154, thereby avoiding warping that is otherwise inherent in the sintering process. Alternately, a single large heat sink may be placed on one side such that all features cool at the same rate and immediately following the sintering operation.

A further aspect of the present invention includes separating contoured details and various tool aspects by a proximate amount such that warping between the features is limited and structural integrity of the features is maximized.

An alternate embodiment of the present invention includes designing in access features or buffer features 179 in areas where warping will occur during sintering such that these features may be removed when the sintering process is concluded. These buffer features 179 may be predetermined such that connection between them and the main body of the part facilitates detachment through a twisting off or breaking off procedure for the buffer feature 179.

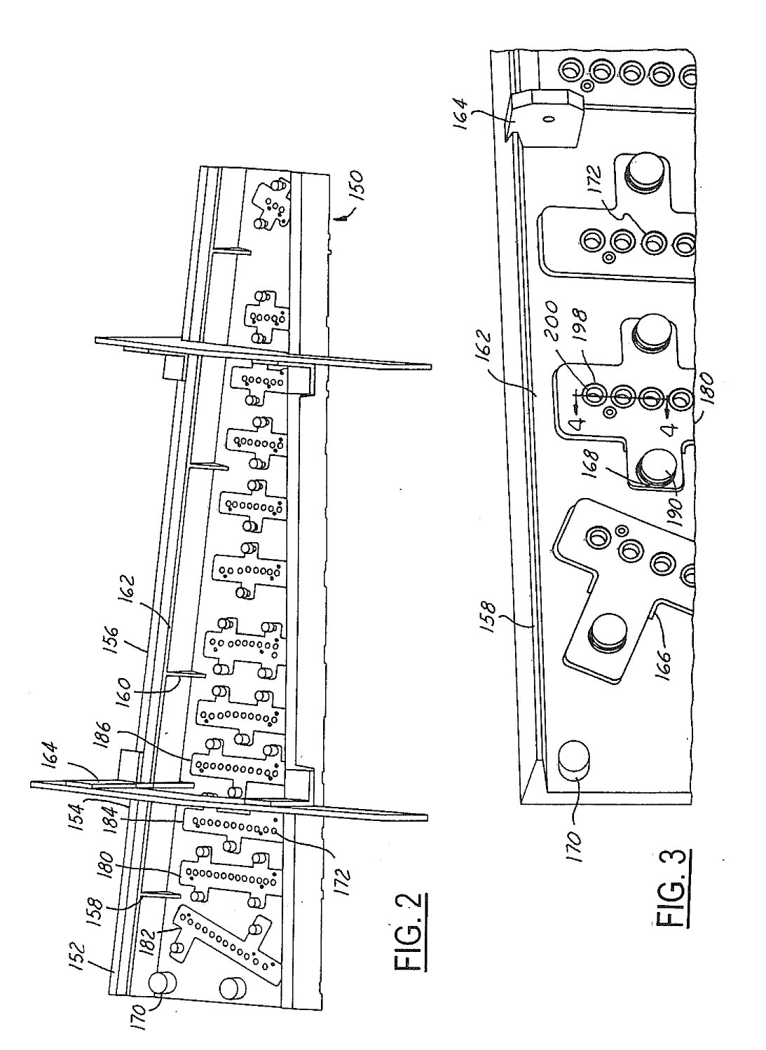

FIG. 4 illustrates a partial cutaway view of a contoured detail 180 of the tool 150 of FIG. 2, looking in the direction of 4-4, in accordance with another embodiment of the present invention. As was mentioned, the contoured details, e.g. 180, define therein a plurality of features including holes or openings, such as 198, 202, and 206, which are strengthened by a plurality of bushings 200, 208, and 210.

For embodied contoured details having short edge distances or patterns of openings with thin walls of the sintered material, opening centerlines tend to migrate when bushings are press fit into the sintered material. To prevent this, the present invention includes bushing attachment operations, wherein the bushings 200, 208, 210 are gently slip fit into the openings 198, 202, 206.

The fit between bushing 200 and opening 198 may include a slip fit operation with a bonding agent used between the bushing 200 and the sintered contoured detail 180 to prevent the migration. This slip fit clearance adds to the bushing location tolerance during fabrication.

In an alternate embodiment of the present invention, assembly features, here embodied as a retaining undercut 218 and applied epoxy 216 at the head 220 of the bushing 200, are included to allow a light press fit between the bushing 200 and the sinter material. The retaining undercut 218, attached through epoxy 216, prevents bushing migration during production usage of the detail 180. The bushing 200 in this embodiment may be easily removed without damage to the detail 180.

The openings 198, 202, 206 include the undercuts 218, 226, 234, which are embodied herein as coaxial with the openings 198, 202, 206 and having greater diameters thereto.

The undercut 218 is grown into the SLS detail in the area of the flange or bushing head 220 attachment. A commercially available epoxy 216 is applied to the undercut 218 overlapping the bushing head 220, the hardened epoxy 216 thereby traps the head 220 of the bushing 200. The undercut 218 includes a flange holding portion or base 223 (bushing flange support ledge), an overhanging portion 225, and a common sidewall 227.

Bushings 200, 208, 210 include heads 220, 221, 228 or flanges such that the bushings 200, 208, 210 may be inserted into the openings 198, 202, 206 and catch on the respective undercuts 218, 226, 234 and attached with epoxy thereto. The bushings 200, 208, 210 further include cylindrical bodies 211, 213, 215, as will be understood by one skilled in the art.

Important to note is that bushings 200, 208, 210 may be attached through a plurality of points through epoxy attached to each bushing head. In other words, the head 220 of bushing 200 is attached at points 216 and 219 to undercut 218; the head 221 of bushing 208 is attached at points 222 and 224 to undercut 226; the head 228 of bushing 210 is attached at points 230 and 232 to undercut 234.

Referring to FIG. 5, logic flow diagram 300 of the method for operating a SLS system is illustrated. Logic starts in operation block 302 where the size of the tool needed is predetermined and attachments required to generate that size of tool are also predetermined. In other words, if the tool requires several sections due to the limitations of the part cylinder 102, the tool is manufactured in a plurality of parts that are joined together through predetermined connectors that are sintered into the sections within the parts cylinder 102.

In operation block 304, the features, such as thickness variations 158, gussets 160, stiffeners 162, interfaces and coordination features 164, construction ball interface and coordination holes 170, trim of pockets and drill inserts 166 and holes 168 provided in details for interface hardware, such as screws, are all predetermined for the tool.

In operation block 306, optimal orientation of the SLS tool design within the parts cylinder is predetermined. In one embodiment of the present invention, this predetermination involves including all features of the tool 150 on the same side of the tool, thereby limiting warping on tool features in accordance with the present invention.

In operation block 308 heat sinks, such as 202, 204, or 206, are positioned in various parts of the parts cylinder 102 such that tool features may be cooled immediately following the sintering process and while the rest of the tool or tool components are being sintered, thereby minimizing warping of the tool features. Alternate embodiments include activating the heat sinks 202, 204, 206 or alternately inputting them into the parts cylinder 102 prior to sintering. Further alternate embodiments include a single heat sink, or a heat sink activating in various regions corresponding to tool features on the tool being sintered.

In operation block 310 the sintering process is activated, and the controller 105 activates the pistons 114, 117, the roller 118, the laser 120, and the mirrors 124. The pistons force sinter material upwards or in a direction of the powder leveling roller 118, which rolls the sinter powder such that it is evenly distributed as a top layer on the parts cylinder 102. The laser 120 is activated and a beam 126 is directed towards scanning gears, which may be controlled as a function of predetermined requirements made in operation block 302. During the sintering operations, the heat sinks 202, 204, 206 are activated for cooling various sintered portions of the tool 150 as they are sintered, and as other parts of the tool are being sintered such that warping is minimized. In alternate embodiments wherein a plurality of tool sections, such as a first and second tool section, are sintered collectively or successively, heat sinks may be included to cool various features of the second tool section as well.

In operation block 312, post-sintering process adjustments are conducted. These adjustments include removing warped portions that were deliberately warped such that tool features would not undergo typical warping associated with the sintering process. Further, post-process adjustments involve fitting together components or sections of the tool 150.

In operation, a method for laser sintering a tool includes predetermining a position for a first tool feature on a first section of the tool. The method further includes predetermining an orientation of the first section of the tool within the part chamber as a function of minimizing warping of the first tool feature during sintering and activating a heat sink within a part chamber for limiting warping of the first tool feature. The first section of the tool is laser sintered within the part chamber.

The method further includes predetermining a position for a second tool feature on a second section of the tool and predetermining an orientation of the second section of the tool within the part chamber as a function of minimizing warping of the second tool feature during sintering. The second section of the tool is laser sintered and coupled to the first section.

A position and configuration of a contoured detail feature is predetermined such that the contoured detail feature includes securing features for coupling strengthening components thereto. The contoured detail is sintered and a strengthening component is coupled thereto, thereby reducing stress on the contoured detail feature. The contoured detail is coupled to at least one of the sections.

From the foregoing, it can be seen that there has been brought to the art a new and improved tooling system and method. It is to be understood that the preceding description of the preferred embodiment is merely illustrative of some of the many specific embodiments that represent applications of the principles of the present invention. Numerous and other arrangements would be evident to those skilled in the art without departing from the scope of the invention as defined by the following claims.

1. A sintering system comprising:
a tool chamber enclosing a sinter material;
a laser system sintering said sinter material as a function of controller signals; and
a controller generating said controller signals as a function of a predetermined contoured detail design defining a feature adapted to receive a strengthening component following sintering operations.

2. The system of claim 1 wherein said feature is defined in said contoured detail as an opening, said opening further defined by predetermined assembly features.

3. The system of claim 2, wherein said predetermined assembly features comprise at least one of an undercut coaxial with said opening or a first flange coaxial with said opening.

4. The system of claim 3, wherein said undercut is defined by a flange supporting portion, an overhanging portion, and a common sidewall.

5. The system of claim 3, wherein said strengthening component comprises a bushing received in said opening and a portion of said bushing contacting or coupling with said undercut or said first flange.

6. The system of claim 5, wherein said bushing comprises a cylinder and second flange extending outwardly from said cylinder, wherein said portion of said bushing comprises said second flange.

7. The system of claim 1, wherein said controller generates said controller signals as a function of defining a plurality of openings for receiving a plurality of strengthening components in said contoured detail.

8. The system of claim 1 further comprising a plurality of heat sinks positioned within said tool chamber for cooling a plurality of predetermined features of said contoured detail, thereby limiting warping of said plurality of predetermined features during sintering of said tool.

9. A method for constructing a tool comprising:
predetermining a position of a contoured detail feature;
predetermining a configuration for said contoured detail feature such that said contoured detail feature comprises securing features for coupling strengthening components thereto;
sintering said contoured detail; and
coupling a strengthening component to said contoured detail feature, thereby reducing stress on said contoured detail feature.

10. The method of claim 9 further comprising coupling said contoured detail to a tool section.

11. The method of claim 9, wherein predetermining said configuration for said contoured detail feature further comprises predetermining a flange supporting portion, an overhanging portion, and a common sidewall within said contoured detail feature.

12. The method of claim 11, wherein coupling said strengthening component further comprises coupling a bushing concentric with said contoured detail feature to said flange supporting portion.

13. The method of claim 12 further comprising applying an epoxy to said flange supporting portion and coupling a flange of said bushing to said flange supporting portion.

14. The method of claim 9 further comprising:
predetermining positions of a plurality of contoured detail features; and
predetermining a configuration for said plurality of contoured detail features such that said plurality of contoured detail features comprise securing features for coupling strengthening components thereto.

15. The method of claim 14 further comprising orienting said contoured detail within sinter chamber such that all of said features are on a same side of said contoured detail.

16. A sintering system comprising:
a part cylinder enclosing a sinter powder;
a laser system sintering said sinter material as a function of controller signals; and
a controller generating said controller signals as a function of a predetermined contoured detail design defining an opening, said opening further defined by an undercut coaxial with said opening, said opening adapted to receive a bushing therein and coaxial thereto following sintering operations, said bushing comprising a flange for coupling said bushing to said undercut.

17. The system of claim 16 further comprising a first heat sink positioned within said tool chamber for cooling at least one of a plurality of predetermined features of a tool on a first tool section, thereby limiting warping of said at least one of said plurality of predetermined features during sintering of said tool, wherein said plurality of predetermined features comprise at least one of a step and thickness variation, a gusset, a stiffener, an interface and coordination feature for making interfaces, a construction ball interface, a coordination hole, a trim of pocket and drill insert, a hole pattern, or a hole for interfacing hardware;
said controller further generating said controller signals as a function of a predetermined tool design, predetermined positions of said plurality of tool features, and a predetermined orientation of said tool section within said part chamber as a function of minimize warping said tool features during sintering, wherein said predetermined tool design comprises a buffer feature protecting at least one of said plurality of predetermined features such that said buffer feature is primarily affected by heat generated during sintering in an area of said at least one of said plurality of predetermined features, wherein said plurality of predetermined features is designed on a same side of said tool.

18. The system of claim 16, wherein undercut comprises a flange supporting portion, an overhanging portion, and a common sidewall.

19. The system of claim 16, wherein a portion of said bushing contacts or couples with said undercut.

20. The system of claim 16, wherein said bushing comprises a cylinder and flange extending outwardly from said cylinder, wherein said portion of said bushing comprises said flange.

21. A method for laser sintering a tool comprising:
predetermining a position for a first tool feature on a first section of the tool;
predetermining an orientation of said first section of the tool within the part chamber as a function of minimizing warping of said first tool feature during sintering;
activating a heat sink within a part chamber for limiting warping of said first tool feature;
laser sintering said first section of the tool within said part chamber;
predetermining a position for a second tool feature on a second section of the tool;
predetermining an orientation of said second section of the tool within said part chamber as a function of minimizing warping of said second tool feature during sintering;
laser sintering said second section of the tool;
coupling said second section to said first section;
predetermining a position of a contoured detail feature;
predetermining a configuration for said contoured detail feature such that said contoured detail feature comprises securing features for coupling strengthening components thereto;
sintering said contoured detail;
coupling a strengthening component to said contoured detail feature, thereby reducing stress on said contoured detail feature; and
coupling said contoured detail to at least one of first section or said second section.

22. The method of claim 21 further comprising predetermining positions of a plurality of tool features on said first section of the tool.

23. The method of claim 22, wherein predetermining said orientation of the tool within the part chamber as a function of minimize warping said tool features further comprises orienting the tool such that all of said tool features are on a same side of the tool.

24. The method of claim 21 further comprising predetermining positions of a plurality of tool features on said second section of the tool.

25. The method of claim 21 further comprising activating a plurality of heat sinks at predetermined times within said part chamber for limiting warping of a plurality of predetermined tool features on either said first section or said second section.

26. The method of claim 21 further comprising predetermining a location of a buffer feature in a close proximity to said first tool feature.

27. The method of claim 26 further comprising removing said buffer feature from the tool following sintering of the tool.

28. The method of claim 21, wherein predetermining positions of said first tool feature further comprise predetermining a position for at least one of a step and thickness variation, a gusset, a stiffener, an interface and coordination feature for making interfaces, a construction ball interface, a coordination hole, a trim of pocket and drill insert, a hole pattern, or a hole for interfacing hardware.

29. The method of claim 21 further comprising coupling said contoured detail to a tool section.

30. The method of claim 21, wherein predetermining said configuration for said contoured detail feature further comprises predetermining a flange supporting portion, an overhanging portion, and a common sidewall within said contoured detail feature.

31. The method of claim 21, wherein coupling said strengthening component further comprises coupling a bushing concentric with said contoured detail feature to said flange supporting portion.

32. The method of claim 31 further comprising applying an epoxy to said flange supporting portion and coupling a flange of said bushing to said flange supporting portion.

33. The method of claim 21 further comprising:
predetermining positions of a plurality of contoured detail features; and
predetermining a configuration for said plurality of contoured detail features such that said plurality of contoured detail features comprise securing features for coupling strengthening components thereto.

34. The method of claim 33 further comprising orienting said contoured detail within sinter chamber such that all of said features are on a same side of said contoured detail.

35. A tool system comprising:
a first section manufactured through a first sintering process comprising at least two mating edges, each of said edges comprising a joint feature;
a first contoured detail manufactured through a second sintering process, said first contoured detail defining an opening, said opening further defined by an undercut in said contoured detail, said undercut comprising a ledge within said opening and coaxial therewith, said first contoured detail coupled to said first section; and
a bushing comprising a flange, said bushing coupled within said opening such that said flange is coupled to said ledge.

36. The system of claim 35 further comprising a second section manufactured through a second sintering process said second section comprising at least two mating edges, each of said edges comprising a joint feature, at least one of said second section joint features designed for coupling to at least one of said first section joint features.

37. The system of claim 35 further comprising epoxy trapped between said flange and said ledge.

38. The system of claim 35, wherein said contour detail is coupled to said first section through either a sintered bolt or a standard bolt or bolting system.

39. A method for sintering a tool comprising:
predetermining a position of a plurality contoured detail openings in a contoured detail;
predetermining a configuration for said contoured detail openings such that each of said contoured detail openings are defined by one of a plurality of ledges for coupling one of a plurality of flanges of one of a plurality of bushings thereto;
sintering said contoured detail; and
coupling said flanges of said bushings to said ledges with an epoxy.

40. The method of claim 39 further comprising coupling said contoured detail to a first tool section.

41. The method of claim 40, wherein coupling said contour detail further comprises coupling said contour detail to said first section through either a sintered bolt or a standard bolt or bolting system.
